(19) United States
(12) Patent Application Publication
(10) Pub. No.: US 2007/0073796 A1
(43) Pub. Date: Mar. 29, 2007

(54) METHOD AND APPARATUS FOR FFT COMPUTATION

(75) Inventors: Lisa Meilhac, Le Cannet (FR); Alain Chiodini, Cagnes Sur Mer (FR)

Correspondence Address: BAKER & DANIELS LLP;111 E. WAYNE STREET, SUITE 800, FORT WAYNE, IN, 46802, US

(73) Assignee: NEWLOGIC TECHNOLOGIES AG, Lustenau (AT)

(21) Appl. No.: 11/532,656

(22) Filed: Sep. 18, 2006

(30) Foreign Application Priority Data
Sep. 23, 2005 (DE) 10 2005 045 519.0

(51) Int. Cl. G06F 17/14

(52) U.S. Cl. 708/404

(57) ABSTRACT

The invention relates to a method and apparatus for computing a 2N-point Fourier transform, direct or inverse, out of a 2N-sample input sequence. According to the invention, a signal processing method and apparatus is provided that makes use of an existing N-point FFT processor as well as other blocks such as a CORDIC or a filter to compute the 2N-point FFT.

### TECHNICAL FIELD OF THE INVENTION

The present invention relates to an IFFT/FFT signal processing method for converting frequency-domain signals into time-domain signals and vice versa. An IFFT/FFT signal processor for performing this method is used for example in any OFDM-based communication system, e.g. WLAN systems according to 802.11a,g standard, where this device plays a key role in the signal processing queue. OFDM (Orthogonal Frequency Division Multiplexing) is a transmission technique based upon the idea of frequency-division multiplexing (FDM), where multiple signals are sent out at the same time, but on different frequencies. In OFDM, a single transmitter transmits on many different orthogonal (independent) frequencies (typically dozens to thousands). An OFDM baseband signal is the sum of a number of orthogonal sub-carriers, with data on each sub-carrier being independently modulated commonly using some type of quadrature amplitude modulation (QAM) or phase-shift keying (PSK). This composite baseband signal is typically used to modulate a main RF carrier. Although the invention is well understood in the context of increasingly popular WLAN systems as HiperLAN2, 802.11a, 802.11g and soon 802.11n to name but a few, it is obvious that it can be applied to any signal processing or communication system implementing an IFFT/FFT processor.

### BACKGROUND OF THE INVENTION

The 802.11n standard, which is currently in the process of being specified, is expected to supersede the 802.11a/g standard by the end of 2006. As we speak, two contending proposals (called TGnSync and Wwise) have been made and are debated. Although none of them has achieved a decisive advantage over the other yet, several features are already looming:
OFDM has been chosen as the modulation mode.
Backward compatibility with 802.11a shall be ensured.
The number of OFDM subcarriers has been increased from 52 to either 56 (in both TGnSync and WWise proposals) when a 20 MHz channel is used or 114 (TGnSync) when a 40 MHz channel is used.

These facts mean that 802.11n modems will need to embed a dual-mode (i.e. 64-point+128-point) IFFT/FFT processor. A 128-point IFFT/FFT is therefore needed to complete the 64-point IFFT/FFT block inherited in a 802.11n modem to make a dual-mode IFFT/FFT processor.

A straightforward solution consists in designing and coding a 128-point FFT from scratch and join it with the existing 64-point FFT to make the dual-mode processor spoken of above. This means we must develop from scratch a 128-point IFFT/FFT block and juxtapose it with the 64-point one. Two separate IFFT/FFT processors which are by the way very likely to feature different radices are thus required to constitute the dual-mode IFFT/FFT processor spoken above. It goes without saying that this solution is very expensive in every aspect since a pretty sizeable project has to be initiated and carried out to fulfill this goal. This approach involves, among other things, finding the necessary human resources, conducting a theoretical study, designing the corresponding Matlab fixed-point model, writing the VHDL file, performing the bit-true verification, etc. Gate count wise, it is anticipated that the size of the dual-mode IFFT/FFT processor will more than double (even triple should we say). The same can be said for the power consuption.

### SUMMARY OF THE INVENTION

It is the object of the invention to provide an IFFT/FFT signal processing method and a related signal processor for computing an 2N-point Fourier transform.

This object is achieved by providing an IFFT/FFT signal processing method and a signal processor as described in the independent claims.

Other features which are considered to be characteristic for the invention are set forth in the dependent claims.

According to the invention, a signal processing method is provided that makes use of an existing N-point FFT processor as well as other blocks such as a CORDIC or a filter to compute a 2N-point FFT.

The invention reuses an existing N-point IFFT/FFT block and integrate it into a greater scheme through either generalizing the butterfly concept or performing adequate low-pass filtering. Thus we can easily compute a 2N-point IFFT/FFT. This approach requires a minimal investment of time, staff and technology and will therefore result in significant savings in terms of men months, gate count (the die size should not grow more than 20 to 40%), power consumption (which matters a lot nowadays) and ultimately cost.

Four embodiments of the invention are proposed. Please note that we restricted ourselves to solely describing the direct FFT. The inverse FFT can be derived from the following block diagrams without any difficulty.

### BRIEF DESCRIPTION OF THE DRAWINGS

FIG. 1 shows a block diagram of a first embodiment of the signal processor according to the invention.

FIG. 2 shows a block diagram of a second embodiment of the signal processor according to the invention.

FIG. 3 shows a block diagram of a third embodiment of the signal processor according to the invention.

FIG. 4 shows a block diagram of a fourth embodiment of the signal processor according to the invention.

### DETAILED DESCRIPTION OF PREFERRED EMBODIMENTS OF THE INVENTION

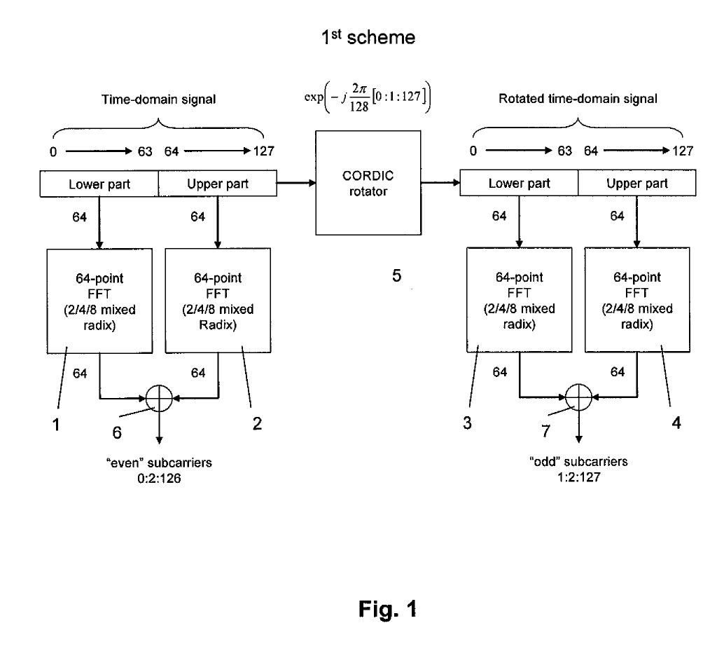

FIG. 1 shows a block diagram of a first embodiment of the signal processor according to the invention. A time domain signal, for example an OFDM baseband signal, consisting for example of N=128 digital samples x(n) is split into a lower part signal x^{lower}(n) and an upper part signal x^{upper}(n) each consisting of N/2=64 samples. The lower part signal X^{lower}(n) and the upper part signal x^{upper}(n) are each input to a 64-point FFT signal processor 1, 2 and subjected in parallel (or consuctively) to a 64-point FFT with 2/4/8 mixed radix. The FFT signal processing results in a lower part frequency domain signal

$${X}_{ \frac{N}{ 2}}^{ lower} ( k )$$

and a upper part frequency domain signal

$${X}_{\frac{N}{2}}^{upper} ( k ) .$$

These two signals

$${X}_{\frac{N}{2}}^{lower} ( k ) and {X}_{\frac{N}{2}}^{upper} ( k )$$

are fed to an adder circuit 6 and added together to form a frequency domain signal comprising the “even” subcarriers 0:2:126 of the OFDM baseband signal.

At the same time, the lower part signal x^{lower}(n) and the upper part signal x^{upper}(n) are input to a CORDIC (Coordinate Rotation Digital Computer) rotator 5 where they are rotated by a phase sequence of

$$exp ( - j \frac{2 π}{128} [ 0 : 1 : 127 ] ) .$$

The rotated lower part signal X^{lower(bis)}(n) and the rotated upper part signal x^{upper(bis)}(n) are each input to a 64-point FFT signal processor 3, 4 and subjected in parallel (or consecutively) to a 64-point FFT with 2/4/8 mixed radix. This results in a rotated lower part frequency domain signal

$${X}_{ \frac{N}{ 2}}^{ lower ( bis )} ( k )$$

and a rotated upper part frequency domain signal

$${X}_{ \frac{N}{ 2}}^{ upper ( bis )} ( k ) .$$

These two signals

$${X}_{ \frac{N}{ 2}}^{ lower ( bis )} ( k ) and {X}_{ \frac{N}{ 2}}^{ upper ( bis )} ( k )$$

are fed to an adder circuit 7 and added together to form a frequency domain signal comprising the “odd” subcarriers 1:2:127 of the OFDM baseband signal.

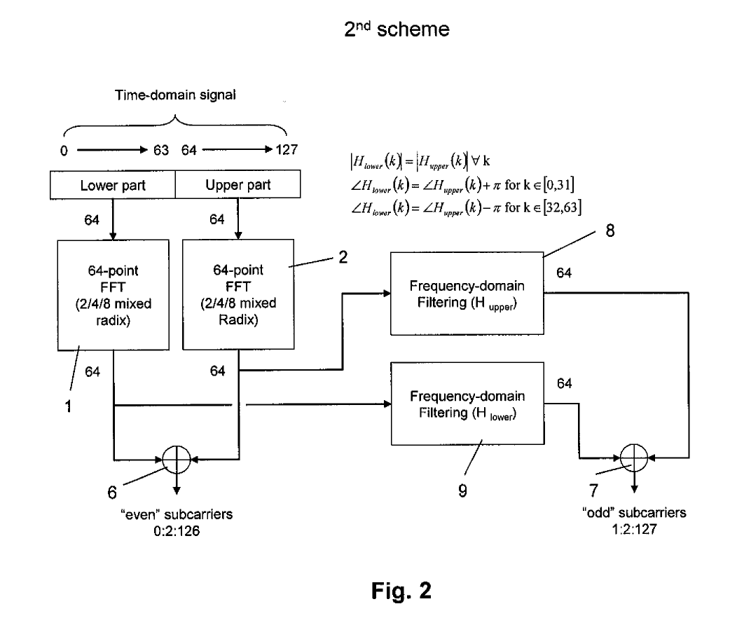

According to a second embodiment of the invention shown in FIG. 2, a time domain signal, for example an OFDM baseband signal, consisting for example of N=128 digital samples x(n) is split into a lower part signal x^{lower}(n) and an upper part signal x^{upper}(n) each consisting of N/2=64 samples. The lower part signal x^{lower}(n) and the upper part signal x^{upper}(n) are each input to a 64-point FFT signal processor 1, 2 and subjected in parallel (or consecutively) to a 64-point FFT with 2/4/8 mixed radix. This results in a lower part frequency domain signal

$${X}_{ \frac{N}{ 2}}^{ lower} ( k )$$

and a upper part frequency domain signal

$${X}_{\frac{N}{2}}^{upper} ( k ) .$$

These two signals

$${X}_{\frac{N}{2}}^{lower} ( k ) and {X}_{\frac{N}{2}}^{upper} ( k )$$

are fed to an adder 6 and added together to form a frequency domain signal comprising the “even” subcarriers 0:2:126 of the OFDM baseband signal.

At the same time, the two signals

$${X}_{\frac{N}{2}}^{lower} ( k ) and {X}_{\frac{N}{2}}^{upper} ( k )$$

are are individually fed to filter circuits 8, 9 and subjected to a frequency domain filtering H_{lower} and Hᵤₚₚₑᵣ, respectively. The complex coeficcients of the frequency domain filters 8, 9 are obtained as follows (matlab notation);

$${H}_{lower} = fft ( exp ( - j \frac{2 π}{128} [ 0 : 63 ] ) ) and$$

$${H}_{upper} = fft ( exp ( - j \frac{2 π}{128} [ 64 : 127 ] ) ) .$$

The filtered lower part frequency domain signal

$${X}_{\frac{N}{2}}^{lower ( filtered )} ( k )$$

and the filtered upper part frequency domain signal

$${X}_{\frac{N}{2}}^{upper ( filtered )} ( k )$$

are then fed to an adder circuit 7 and added together to form a frequency domain signal comprising the “odd” subcarriers 1:2:127 of the OFDM baseband signal.

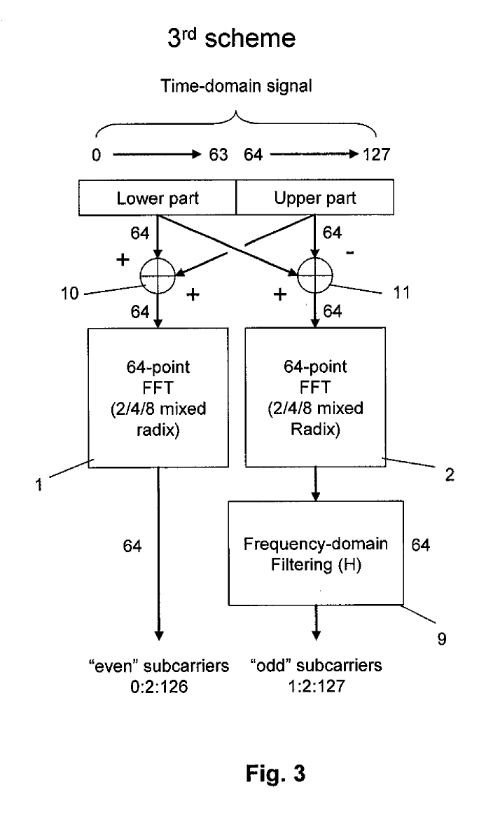

According to a third embodiment of the in invention as depicted in FIG. 3, a time domain signal, for example an OFDM baseband signal, consisting for example of N=128 digital samples x(n) is splitted into a lower part signal x^{lower}(n) and an upper part signal x^{upper}(n) each consisting of N/2=64 samples. In a first branch, the lower part signal x^{lower}(n) and the upper part signal x^{upper}(n) are added by means of an adder circuit 10, input to a 64-point FFT signal processor 1 and subjected to a 64-point FFT with 2/4/8 mixed radix. This results in a frequency domain signal comprising the “even” subcarriers 0:2:126 of the OFDM baseband signal.

In a second branch, the upper signal part x^{uppe}(n) is subtracted from the lower part signal x^{lower}(n) by means of an adder 11 (substactor). The resulting singal is input to a 64-point FFT signal processor 2 and subjected to a 64-point FFT with 2/4/8 mixed radix. This results in a frequency domain signal which is input to a filter circuit 9 and further subjected to a frequency domain filtering

$$H = {H}_{lower} = fft ( exp ( - j \frac{2 π}{128} [ 0 : 63 ] ) ) .$$

The resulting filtered frequency domain signal comprises the “odd” subcarriers 0:2:127 of the OFDM baseband signal.

In the following, the mathematical equations associated with the three embodiments of the invention are set forth. Let us start with some useful notations:
x(n), 0≦n≦N−1, denotes the time-domain signal whose FFT is to be computed.
X_{N}(k), 0≦k≦N−1, denotes the corresponding frequency-domain signal (i.e. the signal obtained after performing an N-point FFT on x(n)).
x^{lower}(n)=x(n),

$$0 \leq n \leq \frac{N}{2} - 1 ,$$
denotes the first halve of x(n).

$${X}_{\frac{N}{2}}^{lower} ( k ) , 0 \leq k \leq \frac{N}{2} - 1 ,$$
denotes the corresponding frequency-domain signal (i.e. the signal obtained after performing an

$$\frac{N}{2} - point FFT$$

on x^{lower}(n)).

$${x}^{upper} ( n ) = x ( \frac{N}{2} + n ) , 0 \leq n \leq \frac{N}{2} - 1 ,$$
denotes the second halve of x(n).

$${X}_{\frac{N}{2}}^{upper} ( k ) , 0 \leq k \leq \frac{N}{2} - 1 ,$$
denotes the corresponding frequency-domain signal (i.e. the signal obtained after performing an

$$\frac{N}{2} - point FFT$$

on x^{upper}(n)).

The drawing FIGS. 1, 2 and 3 associated with each of the three embodiments of the invention illustrate the invention for N=128.

By virtue of the definition of the discrete Fourier transform, we have:

$$\begin{matrix}{X}_{N} ( k ) = {\sum }_{n = 0}^{N - 1} x ( n ) exp ( - j 2 \frac{kn}{N} ) , 0 \leq k \leq N - 1 ⟺ \\ {X}_{N} ( k ) = {\sum }_{n = 0}^{\frac{N}{2} - 1} x ( n ) exp ( - j 2 \frac{kn}{N} ) + \\ {\sum }_{n = \frac{N}{ 2} + 1}^{ N - 1} x ( n ) exp ( - j 2 \frac{kn}{N} ) ⟺ \\ {X}_{N} ( k ) = {\sum }_{n = 0}^{\frac{N}{2} - 1} x ( n ) exp ( - j 2 \frac{kn}{N} ) + \\ {\sum }_{n = 0}^{\frac{N}{2} - 1} x ( \frac{N}{2} + n ) exp ( - j 2 \frac{k ( \frac{N}{2} + n )}{N} ) ⟺ \\ {X}_{N} ( k ) = {\sum }_{n = 0}^{\frac{N}{2} - 1} {x}^{lower} ( n ) exp ( - j 2 \frac{kn}{N} ) + \\ {\sum }_{n = 0}^{\frac{N}{2} - 1} {x}^{upper} ( n ) exp ( - j 2 \frac{k ( \frac{N}{2} + n )}{N} ) ⟺ \\ {X}_{N} ( k ) = {\sum }_{n = 0}^{\frac{N}{2} - 1} {x}^{lower} ( n ) exp ( - j 2 \frac{\frac{k}{2} n}{\frac{N}{2}} ) + \\ {\sum }_{n = 0}^{\frac{N}{2} - 1} {x}^{upper} ( n ) exp ( - j 2 \frac{\frac{k}{2} ( \frac{N}{2} + n )}{\frac{N}{2}} ) ⟺ \\ {X}_{N} ( k ) {\sum }_{n = 0}^{M - 1} {x}^{lower} ( n ) exp ( - j 2 \frac{\frac{k}{2} n}{M} ) + \\ {\sum }_{n = 0}^{M - 1} {x}^{upper} ( n ) exp ( - j 2 \frac{\frac{k}{2} ( M + n )}{M} ) \\ With M = \frac{N}{2}\end{matrix}$$

For “even” subcarriers, i.e. when k=2m with 0≦m≦M−1, we have:

$$\begin{matrix}{X}_{N} ( 2 m ) = {\sum }_{n = 0}^{M - 1} {x}^{lower} ( n ) exp ( - j 2 \frac{m n}{M} ) + \\ {\sum }_{n = 0}^{M - 1} {x}^{upper} ( n ) exp ( - j 2 \frac{m ( M + n )}{M} ) \\ = {\sum }_{n = 0}^{M - 1} {x}^{lower} ( n ) exp ( - j 2 \frac{m n}{M} ) + \\ {\sum }_{n = 0}^{M - 1} {x}^{upper} ( n ) exp ( - j 2 \frac{m M}{M} ) exp ( - j 2 \frac{m n}{M} ) \\ = {\sum }_{n = 0}^{M - 1} {x}^{lower} ( n ) exp ( - j 2 \frac{m n}{M} ) + \\ {\sum }_{n = 0}^{M - 1} {x}^{upper} ( n ) exp ( - j 2 \frac{m n}{M} ) ⟺ \\ {X}_{N} ( 2 m ) = {X}_{M}^{lower} ( m ) + {X}_{M}^{upper} ( m ) \\ = {\underbrace{{FFT}_{M} \{ {x}^{lower} ( n ) \} + {FFT}_{M} \{ {x}^{upper} ( n ) \}}}_{Embodiments \text{:} 1 , 2} \\ = {\underbrace{{FFT}_{M} \{ {x}^{lower} ( n ) + {x}^{upper} ( n ) \}}}_{Embodiment : 3}\end{matrix}$$

It is easy to see that the above equation underlies the three previously depicted embodiments of invention when it comes to calculating the “even” subcarriers.

Now, for “odd” subcarriers, i.e. when k=2m+1 with 0≦m≦M−1, we have:

$$\begin{matrix}{X}_{N} ( 2 m + 1 ) = {\sum }_{n = 0}^{M - 1} {x}^{lower} ( n ) exp ( - j 2 \frac{( m + \frac{1}{2} ) n}{M} ) + \\ {\sum }_{n = 0}^{M - 1} {x}^{upper} ( n ) exp ( - j 2 \frac{( m + \frac{1}{2} ) ( M + n )}{M} ) \\ = {\sum }_{n = 0}^{M - 1} {x}^{lower} ( n ) exp ( - j \frac{n}{N} ) exp ( - j 2 \frac{m n}{M} ) + \\ {\sum }_{n = 0}^{M - 1} {x}^{upper} ( n ) exp ( - j 2 \frac{( M + n )}{N} ) exp ( - j 2 \frac{m n}{M} ) ⟺ \\ {X}_{N} ( 2 m + 1 ) = {FFT}_{M} \{ {x}^{lower} ( n ) exp ( - j 2 \frac{ n}{N} ) \} + \\ {FFT}_{M} \{ {x}^{upper} ( n ) exp ( - j 2 \frac{ M + n}{N} ) \}\end{matrix}$$

The above equation underlies the first embodiment when it comes to calculating the “odd” subcarriers. It can also be rewritten as follows:

$$\begin{matrix}{X}_{N} ( 2 m + 1 ) = {FFT}_{M} \{ {x}^{lower} ( n ) \} * {FFT}_{M} \{ exp ( - j 2 \frac{ n}{N} ) \} + \\ {FFT}_{M} \{ {x}^{upper} ( n ) \} * {FFT}_{M} \{ exp ( - j 2 \frac{ ( M + n )}{N} ) \}\end{matrix}$$

Where * demotes the convolution product.

The above equation underlies the second embodiment when it comes to calculating the “odd” subcarriers.

$$\begin{matrix}{X}_{N} ( 2 m + 1 ) = {\sum }_{n = 0}^{M - 1} {x}^{lower} ( n ) exp ( - j 2 \frac{( m + \frac{1}{2} ) n}{M} ) + \\ {\sum }_{n = 0}^{M - 1} {x}^{upper} ( n ) exp ( - j 2 \frac{( m + \frac{1}{2} ) ( M + n )}{M} ) \\ = {\sum }_{n = 0}^{M - 1} {x}^{lower} ( n ) exp ( - j 2 \frac{n}{N} ) exp ( - j 2 \frac{m n}{M} ) + \\ {\sum }_{n = 0}^{M - 1} {x}^{upper} ( n ) exp ( - j 2 \frac{( M + n )}{N} ) exp ( - j 2 \frac{ m n}{M} ) \\ = {\sum }_{n = 0}^{M - 1} [ {x}^{lower} ( n ) exp ( - j 2 \frac{n}{N} ) - \\ {x}^{upper} ( n ) exp ( - j 2 \frac{( M + n )}{N} ) ] exp ( - j 2 \frac{ m n}{M} ) \\ = {\sum }_{n = 0}^{M - 1} [ {x}^{lower} ( n ) exp ( - j 2 \frac{n}{N} ) + \\ {x}^{upper} ( n ) exp ( - j 2 \frac{M}{N} ) exp ( - j 2 \frac{ n}{N} ) ] exp ( - j 2 \frac{ m n}{M} ) \\ = {\sum }_{n = 0}^{M - 1} [ {x}^{lower} ( n ) exp ( - j 2 \frac{n}{N} ) + \\ {x}^{upper} ( n ) exp ( - j ) exp ( - j 2 \frac{ n}{N} ) ] exp ( - j 2 \frac{ m n}{M} ) \\ = {\sum }_{n = 0}^{M - 1} [ {x}^{lower} ( n ) - {x}^{upper} ( n ) ] exp ( - j 2 \frac{ n}{N} ) exp ( - j 2 \frac{ m n}{M} ) ⟺ \\ {X}_{N} ( 2 m + 1 ) = {FFT}_{M} \{ {x}^{lower} ( n ) - {x}^{upper} ( n ) \} * {FFT}_{M} \{ exp ( - j 2 \frac{ n}{N} ) \}\end{matrix}$$

The above equation underlies the third embodiment when it comes to calculating the “odd” subcarriers.

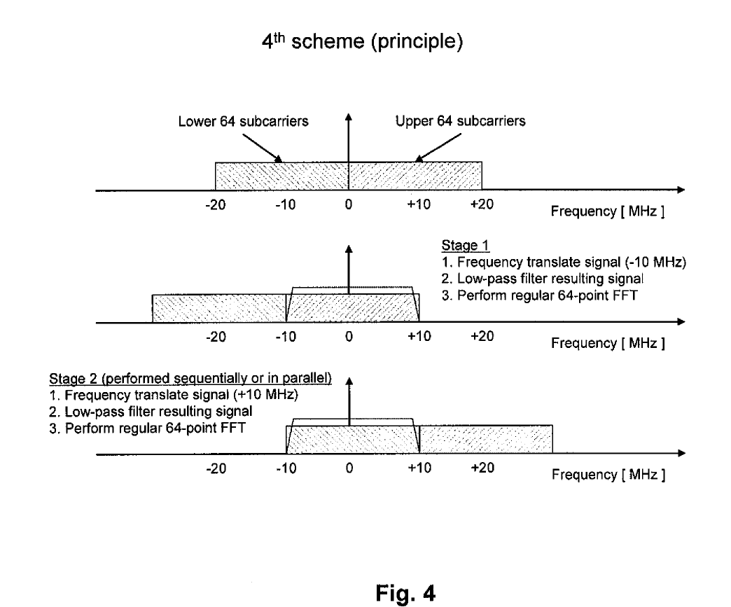

According to a forth embodiment of the invention, FIG. 4a) shows the spectrum of an OFDM baseband signal with 40 MHz channel bandwidth and 128subcarriers. The signal consists of 64 lower subcarriers and 64 upper subcarriers.

With reference to FIG. 4b), for separating the upper 64 subcarriers from the lower 64 subcarriers, the signal is frequency shifted by a negative frequency being a quarter of the channel bandwith, i.e. −10 MHz, so as to center the middle (as expressed in terms of subcarriers) of the upper subcarriers on zero. The frequency shifted signal is then subjected to high pass filtering to eliminate the lower 64 subcarriers. On the resulting upper 64 subcarriers a regular 64-point FFT can be performed.

With reference to FIG. 4c), for separating the lower 64 subcarriers from the upper 64 subcarriers, the signal is frequency shifted by a positive frequency being a quarter of the channel bandwith, i.e. +10 MHz, so as to center the middle (as expressed in terms of suboarriers) of the lower subcarriers on zero. The frequency shifted signal is then subjected to low pass filtering to eliminate the upper 64 subcarriers. On the resulting lower 64 subcarriers a regular 64-point FFT can be performed.

The processing of the upper and the lower subcarriers can be performed sequentially or in parallel using one or two 64-point FFT signal processors.

1. A method for computing a 2N-point Fourier transform, direct or inverse, out of a 2N-sample input sequence S, characterized in that an N-point Fourier transform, direct or inverse, is used.

2. The method of claim 1, characterized in that N is a power of 2.

3. The method of claim 1, characterized in that the N-point Fourier transform is a discrete Fourier transform (DFT), direct or inverse.

4. The method of claim 1, characterized in that the N-point Fourier transform is a fast Fourier transform (FFT), direct or inverse.

5. The method of claim 1, characterized in that the 2N-sample input sequence S is equally divided into two contiguous N-sample subsequences S_{lower} and Sᵤₚₚₑᵣ.

6. The method of claim 5, characterized in that each subsequence S_{lower} and Sᵤₚₚₑᵣ is rotated by a phase sequence:
$$exp ( - j 2 \frac{n}{2 N} )$$
with nε0 . . . N−1 and
$$exp ( - j 2 \frac{n}{2 N} )$$
with nεN . . . 2N−1, respectively, to produce rotated sequences S_{lower(bis)} and S_{upper(bis)}, respectively.

7. The method of claim 6, characterized in that the sequences S_{lower}, Sᵤₚₚₑᵣ, S_{lower(bis)} and S_{upper(bis)} undergo, successively or in parallel, an N-point Fourier transform, direct or inverse, to respectively produce sequences F_{lower}, Fᵤₚₚₑᵣ, F_{lower (bis)} and F_{upper(bis)}.

8. The method of claim 7, characterized in that F_{lower} and Fᵤₚₚₑᵣare added to produce Fₑᵥₑₙ which comprises the even-numbered samples of the 2N-point Fourier transform spanning 0 through 2N−2, and that F_{lower(bis)} and F_{upper(bis)} are added to produce F_{odd} which comprises the odd-numbered samples of the 2N-point Fourier transform spanning 1 through 2N−1.

9. The method of claim 1, characterized in performing a frequency filtering on the sequences to solely compute a direct 2N-point Fourier transform.

10. The method of claim 9, characterized in that the input signal is frequency translated so as to center the middle, as expressed in terms of subcarriers, of its lower half on DC.

11. The method of claim 10, characterized in that the resulting signal is low-pass filtered to produce the samples, i.e. subcarriers, numbered 0 through N−1of the 2N-point Fourier transform.

12. The method of claim 9, characterized in that the input signal is frequency translated so as to center the middle, as expressed in terms of subcarriers, of its upper half on DC.

13. The method of claim 12, characterized in that the resulting signal is high-pass filtered to produce the samples, i.e. subcarriers, numbered respectively N through 2N−1 of the 2N-point Fourier transform.

14. An apparatus for computing a 2N-point Fourier transform, direct or inverse, of a 2N-sample input sequence S, characterized in that it comprises at least one signal processing unit for performing a N-point Fourier transform.

15. The apparatus of claim 14, characterized in that it comprises means for equally dividing the 2N-sample input sequence S into two contiguous N-sample subsequences S_{lower} and Sᵤₚₚₑᵣ.

16. The apparatus of claim 14, characterized in that it further comprises a phase rotator for phase rotating the subsequences S_{lower} and Sᵤₚₚₑᵣ to produce rotated subsequences S_{lower(bis)} and S_{upper(bis)}, respectively.

17. The apparatus of claim 16, characterized in that the phase rotator is a Coordinate Rotation Digital Computer, CORDIC.

18. The apparatus of claim 14, characterized in that it further comprises a digital structure implementing a frequency domain filter coupled to the output of the FFT signal processor.

19. The apparatus of claim 14, characterized in that it further comprises an adder/subtractor for adding/subtracting the input sequences S_{lower} and Sᵤₚₚₑᵣ from each other before they are inputted to the FFT signal processor.

20. The apparatus of claim 14, characterized in that it further comprises an adder for adding sequences F_{lower} and Fᵤₚₚₑᵣ outputted from the FFT signal processor.
